(19) United States
(12) Patent Application Publication
(10) Pub. No.: US 2025/0011202 A1
(43) Pub. Date: Jan. 9, 2025

(54) MODIFIED LIQUID ACTIVATED CARBON (FE-LAC) FOR IN-SITU ARSENIC REMOVAL

(71) Applicants: SAUDI ARABIAN OIL COMPANY, Dhahran (SA); KING FAHD UNIVERSITY OF PETROLEUM & MINERALS, Dhahran (SA)

(72) Inventors: Rayan M. Nasser, Fordos (SA); Muhammad B. Rayaan, Dammam (SA); Mohammad Badruzzaman, Dhahran (SA); Tawfik A. Awadh, Dhahran (SA)

(73) Assignees: SAUDI ARABIAN OIL COMPANY, Dhahran (SA); KING FAHD UNIVERSITY OF PETROLEUM & MINERALS, Dhahran (SA)

(21) Appl. No.: 18/348,045

(22) Filed: Jul. 6, 2023

(51) Int. Cl. C02F 1/68; C02F 1/28

(52) U.S. Cl. CPC C02F 1/68; C02F 1/283; C02F 2101/103; C02F 2103/06

(57) ABSTRACT

A composition for groundwater remediation includes an iron-modified liquid activated carbon which includes a plurality of particles of liquid activated carbon, iron disposed on each surface of the plurality of particles of liquid activated carbon, and an aqueous fluid. A method to produce a composition for groundwater remediation includes producing a liquid activated carbon, and modifying the liquid activated carbon with iron to produce an iron-modified liquid activated carbon. A method for in-situ groundwater remediation includes utilizing a series of chemical injectors to inject an optional first zone with a commercial oxidant and utilizing a series of chemical injections to inject a second zone reactive barrier with an iron-modified liquid activated carbon.

### BACKGROUND

Arsenic compounds (arsenite and arsenate) are known carcinogens, however arsenic contaminated groundwater is still used in developing and underdeveloped countries due to a lack of alternative water supply and/or an adequate treatment process. Arsenic pollution in groundwater at elevated concentrations has been documented in many countries, such as America, Argentina, Bangladesh, Chile, China, India, and Mexico, for example at a concentration range from about 1 μg/L to about 75 milligrams/liter (mg/L). The upper range exceeds the current standard for the maximum contaminant level (MCL) of arsenic in drinking water recommended by the World Health Organization (WHO) is 10 micrograms/liter (μg/L).

A common water treatment material is granular activated carbon (GAC), which has a high surface area that is useful for removing organic pollutants from water. However, due to its negatively charged surface, GAC is not suitable for arsenic removal. Iron-modified GAC has been used to enhance arsenic adsorption; however, iron-modified GAC has typically been used for above-surface contact systems due primarily to its large particle size of approximately 0.2 millimeters (mm) to 5 mm. Furthermore, above-surface contact systems are expensive and generate toxic waste which requires careful handling and disposal. Therefore, there exists a need for an in-situ groundwater remediation which efficiently removes arsenic and is cost effective.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a composition for groundwater remediation, including an iron-modified liquid activated carbon which includes a plurality of particles of liquid activated carbon, iron disposed on each surface of the plurality of particles of liquid activated carbon, and an aqueous fluid.

In another aspect, embodiments disclosed herein relate to a method to produce a composition for groundwater remediation, including producing a liquid activated carbon, and modifying the liquid activated carbon with iron to produce an iron-modified liquid activated carbon.

In yet another aspect, embodiments disclosed herein relate to a method for in-situ groundwater remediation, including utilizing a series of chemical injectors to inject an optional first zone with a commercial oxidant, and utilizing a series of chemical injections to inject a second zone reactive barrier with an iron-modified liquid activated carbon.

Other aspects and advantages of the claimed subject matter will be apparent from the following description and the appended claims.

### BRIEF DESCRIPTION OF DRAWINGS

FIG. 1 shows the chemical structure of iron-modified liquid activated carbon according to one or more embodiments of the present disclosure.

FIG. 2 illustrates a process to produce liquid activated carbon according to one or more embodiments of the present disclosure.

FIG. 3 illustrates a process to modify liquid activated carbon with iron to produce iron-modified liquid activated carbon according to one or more embodiments of the present disclosure.

FIG. 4 shows a reaction scheme to produce iron-modified liquid activated carbon according to one or more embodiments of the present disclosure.

FIG. 5 illustrates a method by which iron-modified liquid activated carbon may be used in a groundwater reservoir to reduce levels of arsenic according to one or more embodiments of the present disclosure.

FIGS. 6A and 6B illustrate scanning electron microscopy (SEM) images of liquid activated carbon and iron-modified liquid activated carbon, respectively, according to one or more embodiments of the present disclosure.

FIGS. 7A and 7B illustrate energy dispersive x-ray analysis (EDX) spectra of liquid activated carbon and iron-modified liquid activated carbon, respectively, according to one or more embodiments of the present disclosure.

FIG. 8 is a graph of Fourier transform infrared (FTIR) spectra of (a) liquid activated carbon and (b) iron-modified liquid activated carbon according to one or more embodiments of the present disclosure.

### DETAILED DESCRIPTION

Embodiments disclosed herein relate to an iron-modified liquid activated carbon, a method for producing the iron-modified liquid activated carbon (Fe-LAC), and an in-situ method for treating groundwater with the Fe-LAC. Combining iron oxide and activated carbon materials for in situ treatment enhances arsenic adsorption capacity. In the iron-modified activated carbon, the iron oxide is active for arsenic removal, and the activated carbon provides a high surface area and acts as a solid support for removal of other organic pollutants.

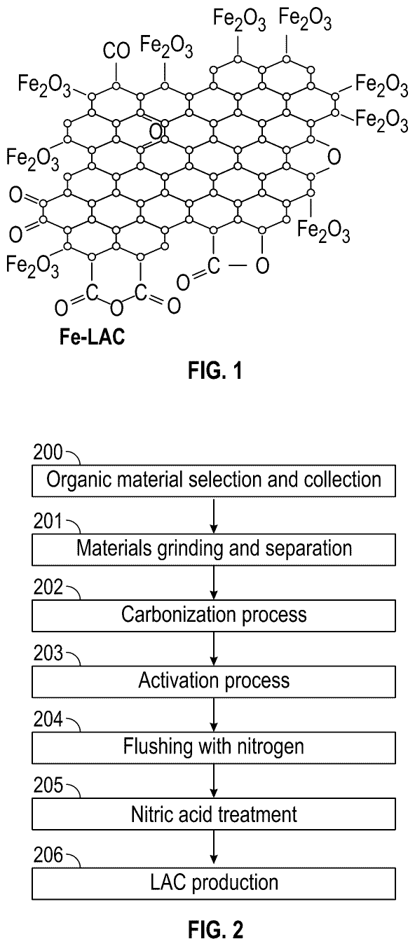

One or more embodiments relate to an iron-modified liquid activated carbon (Fe-LAC). The iron-modified liquid activated carbon includes an aqueous fluid containing small particles of liquid activated carbon which is modified with iron that is disposed on the surfaces of the Fe-LAC particles to produce an iron-modified liquid activated carbon. In one or more embodiments, oxygen is also disposed on the surfaces of the Fe-LAC particles in the form of iron oxide. The liquid activated carbon (LAC) may have a small particle size. The particle size of the LAC may be about 0.1 microns (μm) to about 1 μm. FIG. 1 shows the chemical structure of Fe-LAC according to one or more embodiments.

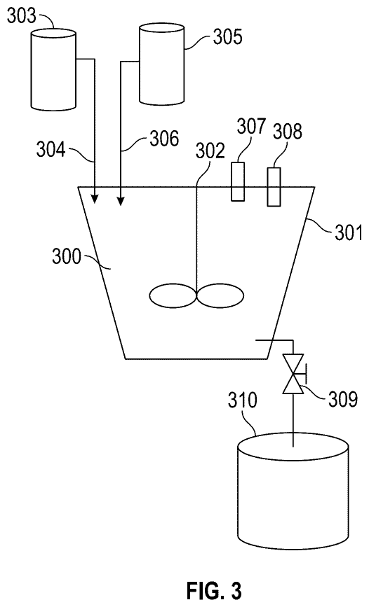

Referring now to FIG. 2, a flow diagram of a process to produce the liquid activated carbon is outlined. In step 200, an organic material is selected and collected before being ground and separated into smaller parts via sieving in step 201. Then, the organic material is carbonized in step 202 into a charred material, also referred to as a “char”. The char is then activated in step 203 before being flushed with nitrogen in step 204 and filtered. Then, the activated carbon solution undergoes nitric acid treatment in step 205 in which nitric acid adds oxygen-containing groups to the activated carbon. Finally, the material is filtered and washed to produce the liquid activated carbon (LAC) in step 206.

In one or more embodiments, a process for producing the iron-modified liquid activated carbon includes producing a liquid activated carbon (LAC). First, at step 200, an organic material is collected and washed to remove dirt. The organic material may be palm fibers. At step 201, the organic material may then be finely ground and separated by a 1 to 2 millimeter (mm) sieve. The particles may then be separated by a 0.1 to 1 μm sieve.

In one or more embodiments, the process for producing the iron-modified liquid activated carbon further includes, at step 202, carbonizing the organic material in a furnace under 99.9% nitrogen gas to produce a char. The char may be carbonized at a temperature of about 445° C. to about 455° C. The carbonizing temperature may be in a range having a lower limit of any one of 445° C., 447° C., and 449° C. and having an upper limit of any one of 451° C., 453° C., and 455° C., where any lower limit may be paired with any mathematically compatible upper limit. The furnace used to produce the carbon material may be any suitable furnace known in the art. The furnace may be, for example, a stainless steel vertical tubular reactor tube furnace.

In one or more embodiments, the process for producing the iron-modified liquid activated carbon further includes, at step 203, activating the char. The char may be activated by washing the char with an organic peroxide, such as hydrogen peroxide, to produce an activated carbon material. In one or more embodiments, the concentration of the organic peroxide is about 4% to about 6%. The concentration of the organic peroxide may be in a range having a lower limit of any one of 4%, 4.5%, and 5% and an upper limit of any one of 5.5% and 6%, where any lower limit may be paired with any mathematically compatible upper limit. In one or more embodiments, the char to organic peroxide ratio used in activating the char is about 1:10 by weight.

In one or more embodiments, the process for producing the iron-modified liquid activated carbon further includes flushing, treating, and washing the activated carbon. At step 204, the activated carbon material is flushed with about 99.9% nitrogen gas to remove air and is subsequently filtered after about 10 hours of stirring to produce a flushed activated carbon material. The flushed activated carbon material is then treated with a nitric acid solution to produce a treated activated carbon material. In one or more embodiments, at step 205, treating the flushed activated carbon material with the nitric acid solution includes adding nitric acid to the flushed activated carbon while stirring under reflux before allowing to cool to produce the treated activated carbon material.

In one or more embodiments, the concentration of nitric acid in the nitric acid treatment is from about 0.8 molar (M) to about 1.2 M. The concentration of the organic peroxide may be in a range having a lower limit of any one of 0.8M, 0.85M, and 0.9 M and having an upper limit of any one of 0.95M, 1M, 1.1M, and 1.2 M, where any lower limit may be paired with any mathematically compatible upper limit.

In one or more embodiments, the ratio of nitric acid to treated activated carbon in the nitric acid treatment is about 20 milliliters (mL) to about 1 gram (g) (nitric acid/treated activated carbon). In one or more embodiments, the temperature of the nitric acid treatment is about 85° C. to about 95° C. The temperature may be in a range having a lower limit of any one of 85° C., 87° C., and 89° C. and having an upper limit of any one of 91° C., 93° C., and 95° C., where any lower limit may be paired with any mathematically compatible upper limit. In one or more embodiments, the stirring time of nitric acid treatment from about 1 hours to about 5 hours, the treated activated carbon material is filtered and washed to produce the LAC. In one or more embodiments, washing the treated activated carbon material to produce the LAC consists of washing the treated activated carbon material at least three times with distilled water.

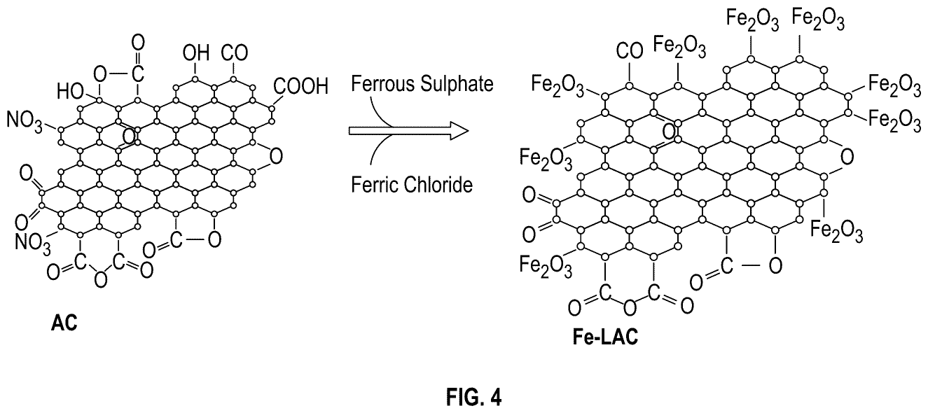

Referring now to FIG. 3, a process to further modify LAC to produce an iron-modified liquid activated carbon (Fe-LAC) is illustrated. A solution of distilled water, an alcohol, and an organic solvent 300 are mixed in a container 301. Then, the prepared LAC is added to the solution in the container 301. The mixture is stirred continuously with a stirrer 302 before a solution of ferrous sulphate 303 is added dropwise 304. Then, ferric chloride 305 is added dropwise 306 to the mixture and the system is again stirred. Afterwards, the pH of the solution is adjusted using a base 307 and subsequently heated 308, while being stirred. Finally, the system is allowed to cool before the iron-modified liquid activated carbon is collected through a valve 309 into a container 310.

In one or more embodiments, a solution of distilled water, an alcohol, and an organic solvent is mixed and added to the LAC to form an activated carbon solution. The alcohol in the solution may be, for example, ethanol. The organic solvent in the solution may be, for example, diethylene glycol. The ratio of distilled water to the alcohol to the organic solvent in the solution is from 15:10:1 to about 10:10:6, for example about 15:10:1.

The ratio of the LAC added to the solution is from about 35 g/L (gram/liter) to about 45 g/L. The ratio of LAC may be in a range having a lower limit of any one of 35 gm/L, 37 g/L, and 39 g/L, and having an upper limit of any one of 41 g/L, 43 g/L, 45 g/L, where any lower limit may be paired with any mathematically compatible upper limit.

The solution of distilled water, an alcohol, an organic solvent, and LAC is stirred continuously for about 6 to about 10 hours to produce the activated carbon solution. Stirring the activated carbon solution may take place in a suitable container known in the art, including, but not limited to, a beaker. Furthermore, stirring the activated carbon solution may occur by any mechanical stirrer known in the art, such as a stir bar.

A ferrous sulphate solution and a ferric chloride solution, for example FeCl₃·6H₂O, are then added dropwise to the activated carbon solution until the formation of brown color media and stirred to form the iron-modified activated carbon solution. The concentration of ferrous sulphate solution added to the activated carbon solution is about 30 g/L to about 40 g/L. The concentration of ferrous sulphate solution may be in a range having a lower limit of any one of 30 g/L, 32 g/L, and 34 g/L and having an upper limit of any one of 36 g/L, 38 g/L, 40 g/L, where any lower limit may be paired with any mathematically compatible upper limit.

The concentration of ferric chloride solution added to the activated carbon solution is from about 90 g/L to about 100 g/L. The concentration of ferric chloride solution may be in a range having a lower limit of any one of 90 g/L, 92 g/L, and 94 g/L and having an upper limit of any one of 96 g/L, 98 g/L, 100 gm/L, where any lower limit may be paired with any mathematically compatible upper limit. The mixture of the ferrous sulphate solution, the ferric chloride solution, and the activated carbon solution is then stirred for about 6 to about 8 hours to produce the iron-modified activated carbon solution.

A base, such as ammonia, is then added to the iron-modified activated carbon solution to adjust its pH. The concentration of the base added to the iron-modified activated carbon solution is from about 0.08 M to about 0.12 M. The concentration of the base may be in a range having a lower limit of any one of about 0.08 M and 0.09 M and having an upper limit of any one of about 1.0 M, 1.1 M, and 1.2 M, where any lower limit may be paired with any mathematically compatible upper limit.

In one or more embodiments, the base is added to the iron-modified activated carbon solution until its pH is greater than about 7. For example, the base may be added to the iron-modified activated carbon solution until the pH is about 7, 8, 9, or 10.

After pH adjustment, the iron-modified activated carbon solution is simultaneously heated and stirred for about 6 to about 10 hours at a predetermined temperature before being allowed to cool. The iron-modified activated carbon solution is then stirred at a temperature of from about 90° C. to about 110° C. The temperature may be in a range having a lower limit of any one of about 90° C., 95° C., and 100° C. and having an upper limit of any one of about 100° C., 105° C., and 110° C., where any lower limit may be paired with any mathematically compatible upper limit. Finally, the iron-modified liquid activated carbon is collected through a valve into a container.

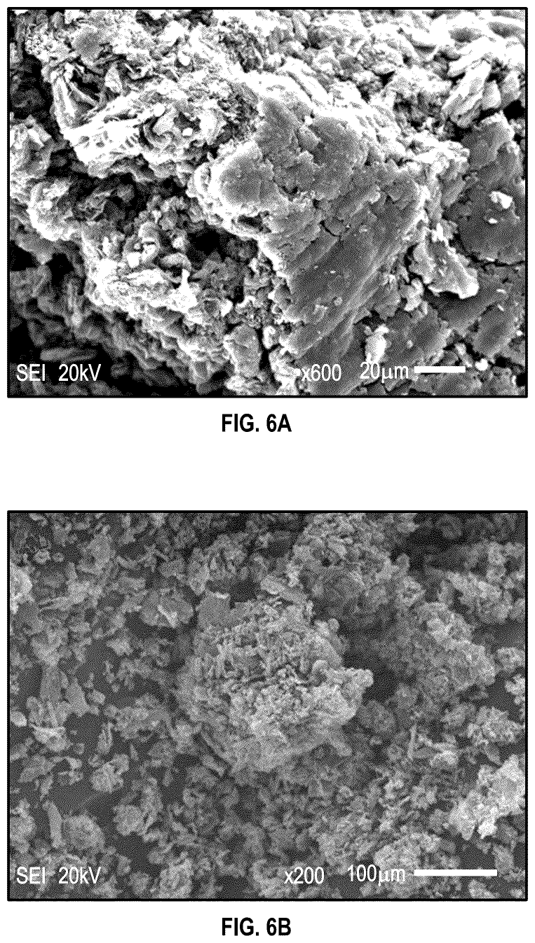

One or more embodiments herein further describe a method for in-situ groundwater remediation to remove arsenic with Fe-LAC, as illustrated in FIG. 5. A groundwater source 500 which is contaminated with arsenic. In FIG. 5, groundwater is monitored by groundwater monitoring wells 506. If the arsenic species is primarily arsenate in the groundwater source, the groundwater source 500 is subjected to an optional first zone 501. Herein, “primarily contaminated with arsenite” is defined as a groundwater which contains 50% or more of arsenite relative to other arsenic contaminates. When the optional first zone 501 is used, a commercial oxidant is injected via a series of chemical injectors 502 at a stoichiometric concentration which converts arsenite to arsenate. A second zone reactive barrier 504 is then injected with Fe-LAC using a series of chemical injectors 503. The amount of the iron-modified liquid activated carbon which is injected into the second zone reactive barrier 504 is determined by using a stoichiometric concentration. The stoichiometric concentration which converts arsenite to arsenate will depend on the type of chemicals used. In one or more embodiments, the commercial oxidant may be permanganate.

Keeping with FIG. 5, the treated, arsenic-free water flows through the second zone reactive barrier 504, as shown by the arrows 505. As the contaminated groundwater 500 flows through the second zone reactive barrier 504 containing Fe-LAC, arsenate in the groundwater will be adsorbed on the Fe-LAC which fills the permeable second zone reactive barrier 504. In other words, a wall filled with Fe-LAC and soil will be created below ground to clean up arsenic contaminated groundwater. The groundwater can flow through the reactive barrier and contaminants will be in contact with Fe-LAC and the removal will take place through adsorption mechanism. Both the optional first zone 501 and the second zone reactive barrier 504 extend to contact a permeable layer 507 through which water can flow.

In one or more embodiments, the width of the second zone reactive barrier is determined by how much water can flow through the second zone reactive barrier with at least 5 minutes contact time. The contact time with the second zone reactive barrier is determined by the groundwater flow rate, the cross-sectional area of the reactive barrier, and may be 5 or 6 or 7 minutes, for example.

As described above, embodiments herein provide a method to produce a liquid activated carbon, a method to modify the liquid activated carbon to produce an iron-modified liquid activated carbon, and a method for in-situ water remediation to remove arsenic in groundwater. Embodiments of the present disclosure may advantageously reduce arsenic in drinking water in an effective and cost efficient manner.

### EXAMPLES

The following examples are provided for the purpose of further illustrating the present compositions and methods but are in no way to be taken as limiting.

### Example 1

Example 1 illustrates preparation of a liquid activated carbon (LAC). The synthesis of the LAC included sieving and carbonization. Palm fibers were collected and washed to remove dirt. The palm fibers were ground to produce ground palm fibers. The ground palm fibers were sieved with a 1-2 millimeter (mm) sieve to separate finely ground palm fibers from the ground palm fibers. The finely ground palm fibers were carbonized in a stainless steel vertical tubular reactor in a tube furnace under 99.9% nitrogen gas at 450° C. to produce a char-like material, also referred to herein as a “char”. It will be understood the char-like material is not a char in the sense of partially burned so as to blacken. Rather, the char-like material is black like char. The char was activated by washing with 5% hydrogen peroxide solution at a char to hydrogen peroxide ratio of 1:10, based on weight percentage to produce a first mixture. Next, the first mixture was flushed with about 99.9% nitrogen gas to remove air and oxygen. After 10 hours of stirring, the first mixture was filtered to produce carbon black. The carbon black was modified with oxygen-containing groups by treatment with nitric acid. The treatment with nitric acid involved adding 1.0 M nitric acid to the carbon black at a 20 mL to 1 g ratio to produce a second mixture. The second mixture was heated up to 90° C. and kept stirring for 3 hours, then allowed to cool. Afterwards, the cooled second mixture was filtered and washed three times with distilled water to produce liquid activated carbon (LAC).

### Example 2

Example 2 illustrates preparation of an iron-modified liquid activated carbon (Fe-LAC). The LAC produced in Example 1 was modified with iron to produce Fe-LAC. A mixture of distilled water, ethanol, and diethylene glycol was prepared in a beaker at a ratio of 15:10:1 based on weight percentage. LAC produced according to Example 1 was added to the mixture of distilled water, ethanol, and diethylene glycol in an amount of 40 gm per liter of the mixture to form a solution. The solution was continuously stirred using a mechanical stirrer for 8 hours. Then, ferrous sulfate was added to the solution drop-wise from a pre-prepared aqueous solution of ferrous sulfate having a concentration of 35 gm Fe per liter pre-prepared solution. Then, ferrous chloride solution (FeCl₃·6H₂O) was added to the solution drop-wise from a pre-made solution of 95 gm Fe per liter of pre-made solution The solution was stirred for 4 hours. After that, the pH of the solution was adjusted to greater than 7 using a 0.1 M ammonia solution. After that, the temperature of the solution was adjusted to 100° C. with stirring for 8 hours. Then, the solution was allowed to cool to produce iron-modified liquid activated carbon. The iron-modified liquid activated carbon was collected from the beaker through a valve into a container.

### Example 3

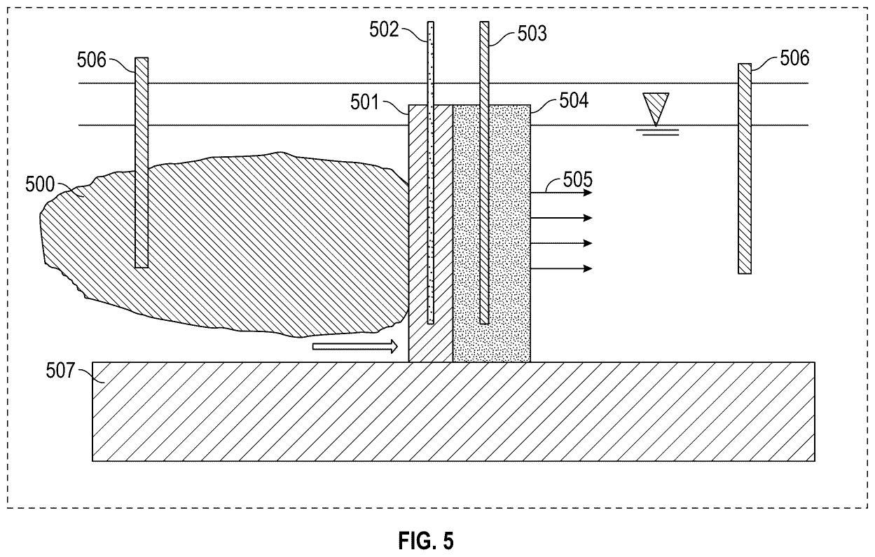

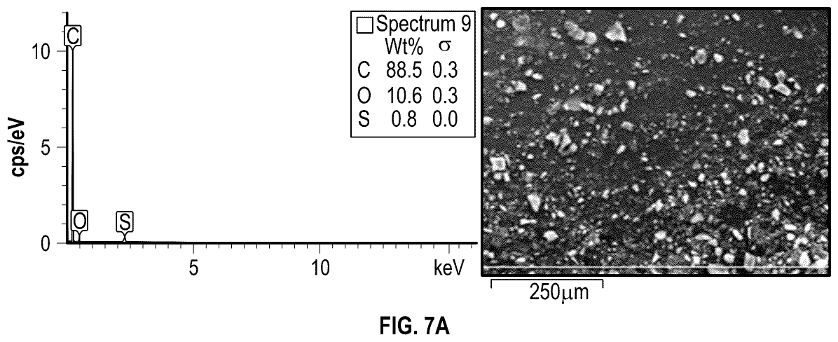

Example 3 illustrates analysis of the properties of the LAC of Example 1 and the Fe-LAC of Example 2. FIGS. 6A and 6B illustrate scanning electron microscopy (SEM) images of the LAC synthesized according to Example 1 (FIG. 6A) and the Fe-LAC synthesized according to Example 2 (FIG. 6B). The SEM images of FIG. 4A show prepared carbon. The surfaces of the prepared carbon in FIG. 6A are free of any dots. In comparison, the SEM images of FIG. 6B shows dots indicating nanoparticles of iron-oxide dotted on the surfaces of the particles of the prepared carbon. The resulting modified surfaces of the iron-modified carbon shown in FIG. 6B are rougher than the surfaces of the prepared carbon shown in FIG. 6A.

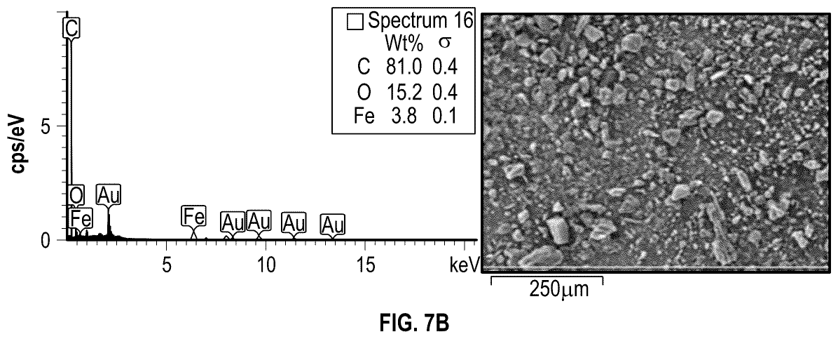

FIGS. 7A and 7B illustrate energy dispersive X-ray (EDX) spectra of the LAC synthesized according to Example 1 (FIG. 7A) and the Fe-LAC synthesized according to Example 2 (FIG. 7B). As shown in FIG. 7A, the main elements of the prepared carbon are carbon and oxygen, which is an indication of the presence of the oxygen functional groups on the carbon surface. The EDX spectra of the iron-modified carbon are presented in FIG. 7B. In addition to carbon and oxygen, iron is shown, indicating the formation of iron oxide on the surface of the prepared carbon.

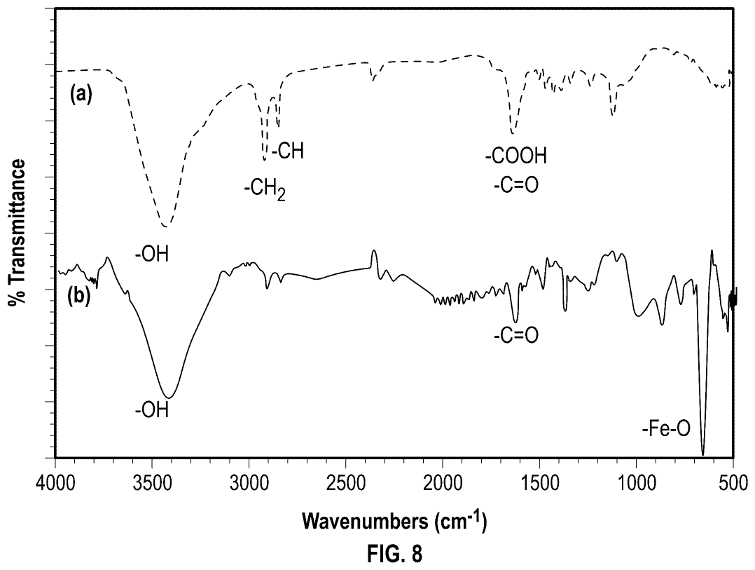

FIG. 8 illustrates FTIR spectra of the LAC synthesized according to Example 1 (a) and the Fe-LAC synthesized according to Example 2 (b). A band located at 1000 to 1100 cm⁻¹ were attributed to (—CO) stretching and (—OH) bending vibrations. A band at around 1450 cm⁻¹ was attributed to (CH2) bending. Bands at around 2920 and 2850 cm⁻¹ were attributed to the bonds of C—H in CH and CH2 on the carbon structure. The band at around 2300 cm⁻¹ was attributed to the C≡N bonds formed as a result of the treatment of carbon with nitric acid. The spectrum exhibits a band at ≈3400-3550 cm⁻¹ attributed to OH stretching vibration. The bands between 1720 and 1600 cm⁻¹ were assigned to carboxylic acids and carbonyl stretching vibration. The bands in the range between 1450 and 1600 cm⁻¹ were assigned to C═C aromatic from the carbon structure. The band at about 1085 cm⁻¹ were assigned to the Fe—O—C bonds. The bands observed at 770 and 890 cm⁻¹ were attributed to Fe—O bending vibrations. The band at 600 cm⁻¹ was attributed to Fe—O stretching vibrations, indicating the possible formation of Fe—O—C.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A composition for groundwater remediation, comprising:
an iron-modified liquid activated carbon, comprising:
a plurality of particles of liquid activated carbon;
iron disposed on each surface of the plurality of particles of liquid activated carbon; and
an aqueous fluid.

2. The composition of claim 1, wherein the plurality of particles of liquid activated carbon range in size from about 0.1 μm to about 1 μm.

3. The composition of claim 1, wherein the iron-modified liquid activated carbon further comprises oxygen disposed on each surface of the plurality of particles of liquid activated carbon.

4. The composition of claim 3, wherein the iron-modified liquid activated carbon comprises the iron and the oxygen as iron oxide disposed on each surface of the plurality of particles of liquid activated carbon.

5. The composition of claim 4, wherein the iron-modified liquid activated carbon comprises the iron oxide as a plurality of iron oxide nanoparticles, each disposed on one of the plurality of particles of liquid activated carbon.

6. A method to produce a composition for groundwater remediation, comprising:
producing a liquid activated carbon; and
modifying the liquid activated carbon with iron to produce an iron-modified liquid activated carbon.

7. The method of claim 6, wherein producing the liquid activated carbon further comprises:
collecting, washing, and grinding an organic material;
carbonizing the organic material to produce a char;
activating the char by washing with an organic peroxide to produce an activated carbon material;
flushing, treating, and washing the activated carbon material to produce the liquid activated carbon.

8. The method of claim 7, wherein flushing, treating, and washing the activated carbon material to produce the liquid activated carbon further comprises:
flushing the activated carbon material with nitrogen gas to produce a flushed activated carbon material;
treating the flushed activated carbon material with a nitric acid solution to produce a treated activated carbon material; and
washing the treated activated carbon material with distilled water to produce the liquid activated carbon.

9. The method of claim 6, wherein modifying the liquid activated carbon with iron to produce the iron-modified liquid activated carbon further comprises:
mixing a solution of distilled water, an alcohol, and an organic solvent with the liquid activated carbon to form an activated carbon solution;
adding a ferrous sulphate solution and a ferric chloride solution to the activated carbon solution and stirring to form an iron-modified activated carbon solution;
adding a base, while simultaneously heating and stirring, to the iron-modified activated carbon solution to produce the iron-modified liquid activated carbon;
cooling the iron-modified liquid activated carbon; and
collecting the iron-modified liquid activated carbon.

10. A method for in-situ groundwater remediation, comprising:
utilizing a series of chemical injectors to inject an optional first zone with a commercial oxidant; and
utilizing a series of chemical injections to inject a second zone reactive barrier with an iron-modified liquid activated carbon.

11. The method of claim 10, wherein the optional first zone is utilized if the groundwater is primarily contaminated with arsenite.

12. The method of claim 10, wherein the commercial oxidant is injected into the optional first zone at a stoichiometric concentration sufficient to convert arsenite to arsenate.

13. The method of claim 10, wherein the optional first zone and the second zone reactive barrier extend to a permeable layer.
